(19) United States
(12) Patent Application Publication
(10) Pub. No.: US 2012/0255844 A1
(43) Pub. Date: Oct. 11, 2012

(54) SWITCH MODULE

(75) Inventor: JUNG-HUI HSU, New Taipei City (TW)

(73) Assignee: POWERTECH INDUSTRIAL CO., LTD., NEW TAIPEI CITY (TW)

(21) Appl. No.: 13/244,519

(22) Filed: Sep. 25, 2011

(30) Foreign Application Priority Data
Apr. 8, 2011 (TW) 100112348

(51) Int. Cl. H01H 23/04

(52) U.S. Cl. 200/293

(57) ABSTRACT

A switch module is disclosed. The switch module includes a casing, a plurality of conductive terminals and a switching part. The conductive terminals are mounted on the casing and the switching part is connected to the casing pivotally. At least one of the conductive terminals is a clamping unit that is capable of piercing an insulation layer of a cable before electrically connecting to a conductive core of the cable. Thus, the cable may be electrically connected to the conductive terminal without detaching from the conductive terminal.

### BACKGROUND OF THE INVENTION

1. Field of the Invention

The present invention relates to a switch module; in particular, to a switch module of switching power supply, which has an clamping unit.

2. Description of Related Art

Generally, an extension cord or any other electrical appliances are equipped with a switch module for selectively turning on or off electrical connection between the electrical appliances and an electric power input interface that is coupled to a power source.

As shown in FIG. 1 which is a schematic diagram of a conventional switch module 1, the switch module 1 includes a casing 10, a switch button 11, a first conductive terminal 131, a second conductive terminal 132, and a third conductive terminal 133. A switch button 11 is pivotally set on the casing 10. The first conductive terminal 131, the second conductive terminal 132, and the third conductive terminal 133 are respectively mounted on the casing 10. The first conductive terminal 131 and the second conductive terminal 132 are able to electrically connect to the electric power input interface (not shown in FIG. 1) through a cable 15, and the third conductive terminal 133 is able to connect to electronic circuits (not shown in FIG. 1) through a contact piece 17.

As shown in FIG. 1, the cable 15 has a conductive core 151 and an insulation layer 153. The conductive core 151 exposed out of the insulation layer 153 is usually fixed at the first conductive terminal 131 and the second conductive terminal 132 by spot welding after being bent. In addition, the contact piece 17 may pivotally joint to the third conductive terminal 133 via the pivot joint component 16, which passes through a first puncture 130 of the third conductive terminal 133 and the second puncture 170 of the contact piece 17.

However, the process of spot welding the conductive core 151 is relatively complicated. Moreover, when the temperature of the first conductive terminal 131 or the second conductive terminal 132 rises because of over-load, the conductive core 151 may detach from the location where the conductive core 151 is spot welded. And the detachment of the conductive core 151 may therefore disconnect the electrical appliances from the power source.

### SUMMARY OF THE INVENTION

The object of the present invention is to minimize occurrence of detachments between the conductive terminals of the switch module and the power source.

In order to achieve the aforementioned objects, according to an embodiment of the present invention, a switch module is disclosed. The switch module includes a casing, a plurality of conductive terminals, and a switching part. The conductive terminals are mounted on the casing, and the switching part is pivotally set at the casing. At least one of the conductive terminals may serve as an clamping unit, for piercing an insulation layer of a cable before electrically connecting to a conductive core of the cable. The switching part is able to selectively contact with two of the conductive terminals simultaneously or only one of the conductive terminals.

In addition, another embodiment of the present invention further discloses a switch module having a casing, a plurality of conductive terminals, a switching part, and a base. The conductive terminals are mounted on the casing, and the switching part is pivotally set at the casing. The base includes a plurality of wire containing slots and a terminal slot. Each of the wire containing slots has an clamping unit, and the wire containing slots may intersect with the terminal slot. The terminal slot is adapted for accommodating the conductive terminals. The clamping units are for piercing an insulation layer of a cable which passes through the wire containing slots, and for electrically connected to a conductive core of the cable. When the conductive terminals are contained in the terminal slot, the conductive terminals contact with the clamping units correspondingly and respectively. Thus, after the clamping units pierce the cable, the conductive terminals are electrically connected with the cable by contacting the clamping units.

On the basis of the above, the embodiments of the present invention disclose switch modules equipped with the clamping unit, for piercing and even firmly securing the cable, simplifying the manufacturing processes of the switch module.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a schematic diagram of a conventional switch module;

FIGS. 2A to 2C are schematic diagrams of a switch module according to one embodiment of the present invention;

FIGS. 2D to 2E are schematic diagrams of a switch module according to another embodiment of the present invention;

FIGS. 3A to 3B are schematic diagrams of a switch module according to another embodiment of the present invention; and

FIG. 4A to 4C are circuit diagrams of the switch module according to an embodiment of the present invention.

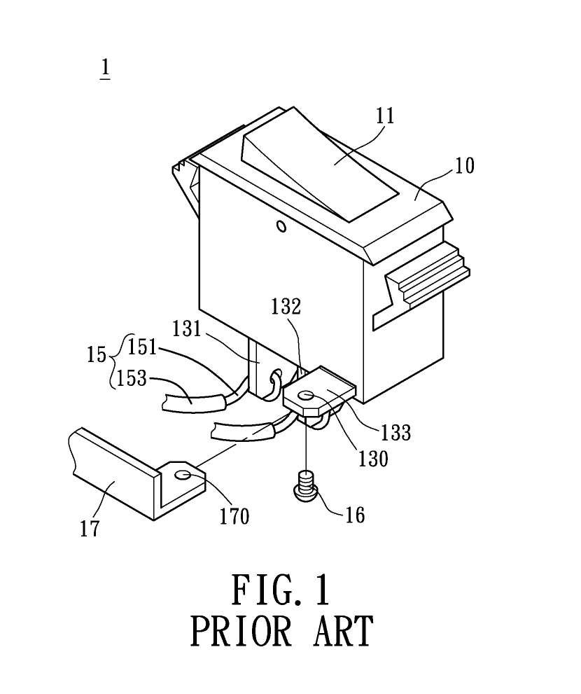

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

The present specification discloses a switch module which may electrically connect with a cable by using insulation displacement structures. The manufacturing processes of the switch module may be simplified, and the simplified manufacturing process increases manufacturing efficiency.

### First Embodiment

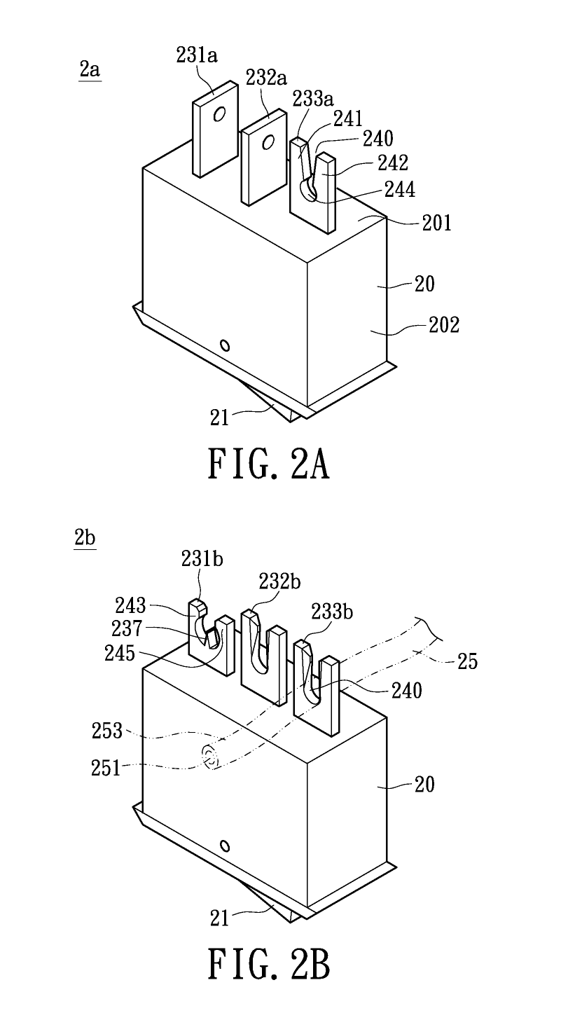

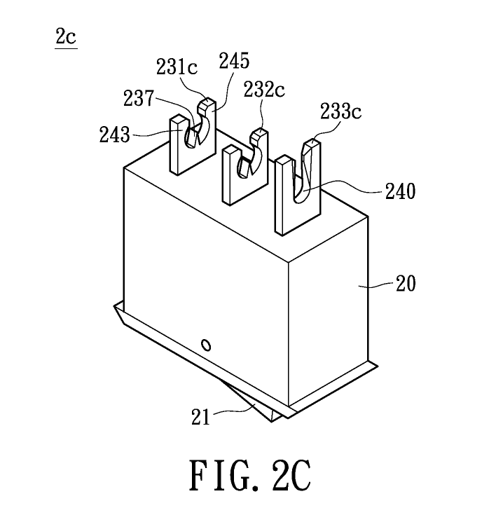

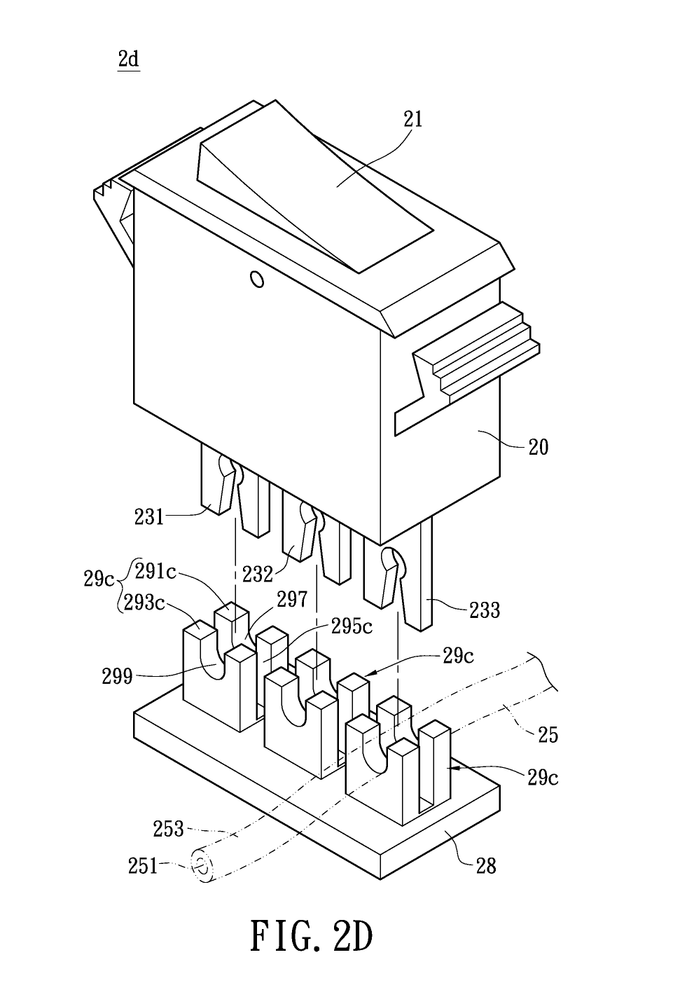

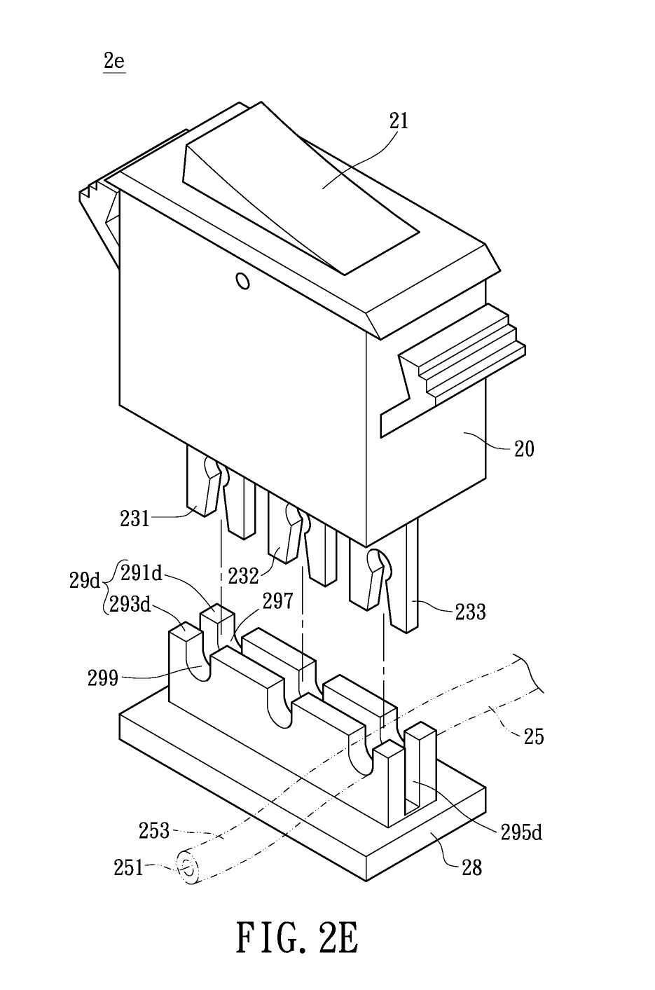

Please refer to FIGS. 2A to 2B. FIG. 2A and FIG. 2B are schematic diagrams according to one embodiment of the present invention. As shown in FIG. 2A, a switch module 2a includes a casing 20, a first conductive terminal 231a, a second conductive terminal 232a, a third conductive terminal 233a, and a switching part 21. The conductive terminals 231a, 232a, and 233a are mounted on the casing 20. More specifically, in one implementation, the conductive terminals 231a, 232a, and 233a extend from inside of the casing 20 to outside of the casing 20. The switching part 21 may be pivotally and movably set on the casing 20.

The switching part 21 may be adapted to selectively contact with two of the conductive terminals 231a, 232a, and 233a. For example, the switching part 21 may be in contact with the first conductive terminal 231a and the third conductive terminal 233a. Alternatively, the switching part 21 may contact with one of the two conductive terminals (e.g., the conductive terminal 231a or the conductive terminal 233a). Consequently, the switching part 21 may electrically connect the conductive terminals 231a and 233a or disconnect the conductive terminal 231a from the conductive terminal 233a. More specifically, when the switching part 21 is switches to “on,” the switching part 21 may connect the first conductive terminal 231a to the third conductive terminal 233a. On the other hand, when the switching part 21 is switched to “off,” the switching part 21 may cause the first conductive terminal 231a to be disconnected from the third conductive terminal 233a. The switching part 21 is not limited to connecting/disconnecting the first conductive terminal 231a and the third conductive terminal 233a. In other words, the switching part 21 may also be designed for connecting/disconnecting the first conductive terminal 231a and the second conductive terminal 232a, or the second conductive terminal 232a and the third conductive terminal 233a.

In one implementation, the third conductive terminal 233a may be installed on a first side of the casing 20 when the first conductive terminal 231a and second conductive terminal 232a are installed on a second side of the casing 20 with the first side being opposite to the second side. For example, the first conductive terminal 231a and the second conductive terminal 232a are installed on the first side 201 of the casing 20, and the third conductive terminal 233a is installed on the second side 202 of the casing 20. Thus, the position of the conductive terminals 231a, 232a, and 233a may be arranged in accordance with cables of different electric appliances or different socket devices.

One of the conductive terminals 231a, 232a, and 233a may be an clamping unit. For instance, the third conductive terminal 233a may be the clamping unit, and the first conductive terminal 231a and the second conductive terminal 232a may be metal pieces. It is worth noting that the number of the conductive terminals being the insulation displacement is not limited. As shown in FIG. 2B, the conductive terminals 231b, 232b, and 233b of the switch module 2b are all clamping units.

The clamping unit may be made of conductive materials, so that the clamping unit may be capable of piercing an insulation layer 253 of the cable 25 before establishing an electrical connection with a conductive core 251 of the cable 25. For example, as shown in FIG. 2A, the clamping unit (such as the third conductive terminal 233a) has a first clip arm 241 and a second clip arm 242 with a passage 240 formed between the first clip arm 241 and the second clip arm 242. The first clip arm 241 and the second clip arm 242 may be adapted to peel off the insulation layer 253 of the cable 25 passing through the passage 240 before clamping the conductive core 251 within the cable 25. In practice, the first clip arm 241 and the second clip arm 242 can be considered as thin blades disposed around the passage 240. A holding part 244 may be located between the first clip arm 241 and the second clip arm 242 in order to firmly hold the cable 25 when width of the holding part 244 is wider than the width of the passage 240. Accordingly, the cable 25 may be stopped from departing the clamping unit through the opening of the passage 240. The holding part 244 is in a gas communication with the passage 240.

As shown in FIG. 2B, the clamping unit (such as the first conductive terminal 231b) according to another embodiment having a first clip arm 243 and a second clip arm 245 further includes a spike part 237 between the first clip arm 243 and the second clip arm 245. The spike part 237 may be for piercing the insulation layer 253 of the cable 25 before contacting the conductive core 251 of the cable 25.

It is worth noting that the appearance of the clamping unit is not restricted to the appearances shown in FIGS. 2A and 2B, the clamping unit may be also made by technique of insulation displacement contact (IDC).

Additionally, the cable 25 may be securely positioned by with the conductive terminals 233c, 231b, 232b, and 233b serving as the clamping units that are capable of piercing the cable 25 through which the electrical connection between the conductive terminals and the cable 25 may be established, when the cable 25 is pressed into the passage or the holding part mechanically or by human forces.

Furthermore, the present invention does not limit the arrangement of the conductive terminals. As shown in FIG. 2C, all of the conductive terminals 231c, 232c, 233c can be disposed in parallel fashion, so that the conductive terminal 232c can be sandwiched between the conductive terminal 231c and the conductive terminal 233c. To be noted, for the person skilled in the art can determine whether each of the conductive terminals should be collocated with the spike part or the blade-like clip arms by himself. For example, the spike part 237, of course, can be collocated with any of the illustrated conductive terminals, and the first clip arm 243 and the second clip arm 245 of each conductive terminal can also be selectively manufactured in blade fashion around the passage 240 in accordance with user's requirements.

### Second Embodiment

Please refer to FIGS. 2D to 2E. FIG. 2D and 2E are schematic diagrams of a switch module according to another embodiment of the present invention. As shown in FIG. 2D, when compared with the switch modules 2a/2b/2c a switch module 2d also includes the conductive terminals 231, 232, and 233 serving as the clamping units. One difference between embodiments 2a/2b/2c and 2d lies in the switch module 2d further includes a base 28 on which a wire arranging part 29c is arranged allowing for the cable 25 to pass through, and accommodating the conductive terminals 231, 232, and 233.

The wire arranging part 29c further includes a plurality of first lumps 291c and a plurality of second lumps 293c. The first lumps 291c are spaced from each other and installed corresponding to their respective second lumps 293c. Pairs of the first lumps 291c and their corresponding second lumps 293c may be installed at positions on the base 28 which correspond to locations of the conductive terminals 231, 232, and 233. A terminal slot 295c may be formed between the first lump 291c and the corresponding second lump 293c. A plurality of terminal slots 295c may be used for containing the conductive terminals 231, 232, and 233.

In one implementation, every first lump 291c may be associated with a first wire containing slot 297, and every second lump 293c may be associated with a second wire containing slot 299. The first wire containing slot 297 and the corresponding second wire containing slot 299 in one implementation may align along with a same axis, and the first wire containing slot 297 and the second wire containing slot 299 may intersect with the terminal slot 295c. In one implementation, the first wire containing slot 297 and the second wire containing slot 299 may be perpendicular to the terminal slot 295c.

In practice, the cable 25 may be arranged in the first wire containing slot 297 and the corresponding wire containing slot 299 in advance, before the conductive terminals 231, 232, and 233 may be put into the corresponding terminal slots 295c. When the conductive terminals 231, 232, and 233 have been entering into the terminal slots 295c, the insulation layer 253 of the cable 25 contained within the first wire containing slot 297 and second wire containing slot 299 may be peeled off by the conductive terminals 231, 232, and 233 which have insulation displacement structures. In addition, the conductive core 251 of the cable 25 may be clamped by the conductive terminals 231, 232, and 233 that have the insulation displacement structures.

In the present embodiment, shapes and locations of the first lumps 291c and the second lumps 293c are not limited to the example shown in FIG. 2D. Moreover, the plurality of first lump 291c may be joined together as one monolithic structure with the plurality of second lumps 293c may also be integrated in a monolithic form.

FIG. 2E shows another switch module 2e having a wire arranging part 29d with a first lump 291d and a second lump 293d. The first lump 291d and the second lump 293d may be correspondingly installed. A space between the first lump 291d and the second lump 293d may serve as a terminal slot 295d, in which the conductive terminal 231, 232, or 233 may be accommodated.

The first lump 291d may be associated with a plurality of first wire containing slots 297, and the second lump 293d may be associated with a plurality of second wire containing slots 299. The corresponding first wire containing slot 297 and the second wire containing slot 299 may align along a same axis as shown in FIG. 2E. Each pair of first wire containing slot 297 and second wire containing slot 299 may be located corresponding to the location of the conductive terminal 231, 232, or 233. The first wire containing slot 297 and the second wire containing slot 299 may intersect with the terminal slot 295d. For example, the first wire containing slot 297 and the second wire containing slot 299 may be perpendicular to the terminal slot 295d.

Therefore, the wire arranging part 29d of the switch module 2e may accommodate several conductive terminals 231, 232, and 233 and the cable 25 simultaneously, and may be capable of minimizing occurrences of detachment of the cable 25 from the conductive terminals 231, 232, and 233.

### Third Embodiment

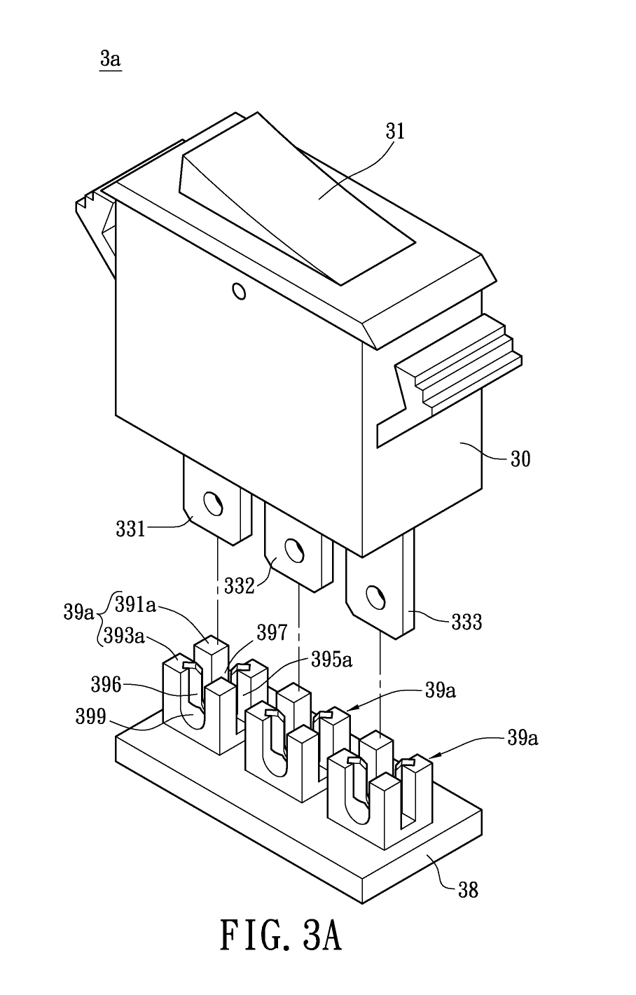

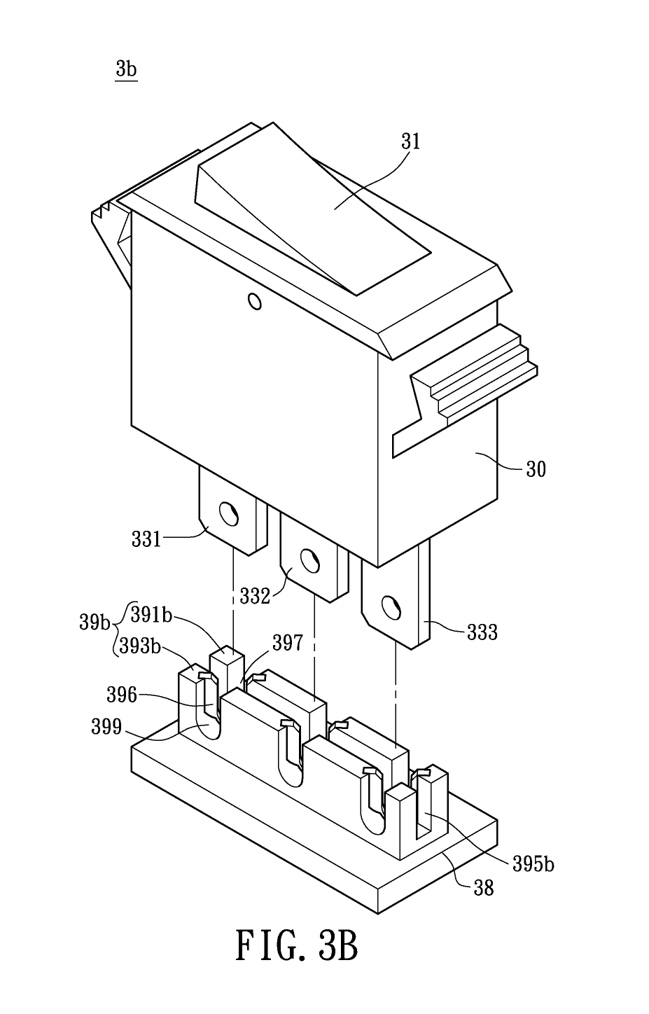

Please refer to FIGS. 3A to 3B. FIGS. 3A to 3B are schematic diagrams of a switch module according to another embodiment of the present invention. As shown in FIG. 3A, a switch module 3a resembles its counterpart shown in FIG. 2C (i.e., the switch module 2c). In other words, the switch module 3a also includes a switching part 31 and a plurality of conductive terminals 331, 332, and 333 arranged on the casing 30, and a base 38. However, the embodiment 3a differs to the embodiment 2c in none of the conductive terminals 331, 332, and 333 of the switch module 3a are in the form of the insulation displacement structure. Rather, the insulation displacement structures are set at the base 38.

The base 38 are substantially the same as the base 28 in FIG. 2C. In other words, a wire arranging part 39a is installed on the base 38. The wire arranging part 39a has a plurality of first lumps 391a and a plurality of second lumps 393a and spaces between the first lumps 391a and the corresponding second lumps 393a may serve as terminal slots 395a. Meanwhile, every first lump 391a has a first wire containing slot 397 and every second lump has a second wire containing slot 399. In addition, the differences between the second embodiment and the third embodiment include that the wire arranging part 39a further has a plurality of clamping units 396, which are respectively placed between pairs of the first wire containing slots 397 and the second wire containing slots 399. More specifically, the first clip arm (not marked) of every clamping unit 396 is installed adjacent to or embedded into the first wire containing slot 397, and the second clip arm (not marked) of the clamping unit 396 is also installed adjacent to or embedded to the second wire containing slot 399. The passage (not marked) between the first clip arm and the second clip arm is in the gas communication with the first wire containing slot 397, the second wire containing slot 399, and the corresponding terminal slot 395a.

Therefore, the cable may be arranged in several pairs of the first wire containing slots 397 and the second wire containing slots 399 in advance before the conductive terminals 231, 232, and 233 may be pressed into the corresponding terminal slots 395a, so that the insulation layer of the cable may be pierced and peeled off by the clamping units 396. In addition, the conductive core of the cable may be clamped by the clamping units 396. At the same time, the conductive terminals 331, 332, and 333 may be in contact with the first clip arm and the second clip arm through the passage associated with the corresponding clamping unit 396. Thus, the conductive terminals 331, 332, and 333 may be electrically connected with the conductive core of the cable.

In this embodiment, the shapes and the locations of the first lumps 391a and the second lumps 393a are not limited to the example shown in FIG. 3A. Moreover, several first lump 391a may be joined together as one monolithic first lump 391a. Similarly, several second lumps 393a may also be joined as a single one.

As shown in FIG. 3B, the wire arranging part 39b of the switch module 3b includes a first lump 391b, a second lump 393b, and a plurality of clamping units 396. The first lump 391b has a plurality of first wire containing slots 397, and the second lump 393b has a plurality of second wire containing slots 399. Every clamping unit 396 may be arranged between every pair of the first wire containing slot 397 and the second wire containing slot 399.

In practice, the cable may be pressed into the clamping units 396 in advance, and the conductive terminals 331, 332, and 333 may be in contact with the clamping units 396. Thus, the cable may be electrically connected with the conductive terminals 331, 332, and 333 without being spot welded.

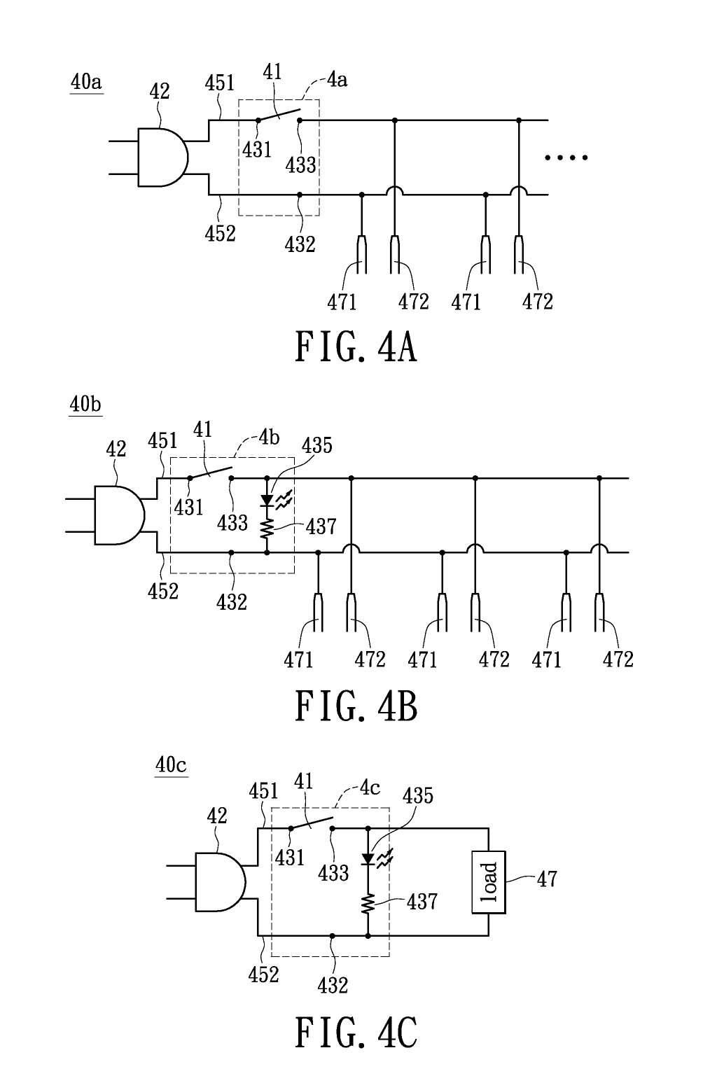

Please refer to FIGS. 4A to 4C. FIGS. 4A to 4C are circuit diagrams of the switch module according to an embodiment of the present invention. As shown in FIG. 4A, a switch circuit 4a may be used in a socket device 40a. The switch circuit 4a may include a first contact point 431, a second contact point 432, a third contact point 433, and a switch component 41. The first end of the switch component 41 is connected to the first contact point 431, and the second end of the switch component 41 may be selectively connected to the third contact point 433.

Taking switch module 2a for example, the switch circuit 4a may be set inside the casing 20. The first contact point 431 may be electrically connected to the first conductive terminal 231a, the second contact point 432 may be electrically connected to the second conductive terminal 232a, and the third contact point 433 may be electrically connected to the third conductive terminal 233a. The switch component 41 is controlled by the switching part 21, so that the switch component 41 may be electrically connected to the first contact point 431 and the third contact point 433 at the same time, or electrically connected to the first contact point 431 only. The switch circuit 4a, in another implementation, may be also installed in the switch module 2b, 2c, 2d, 3a, and 3b.

The first contact point 431 may be connected to a live wire end 451 of the cable, and the second contact point 432 may be connected to a neutral wire end 452 of the cable. The first contact point 431 and the second contact point 432 are electrically connected with an electric power input interface 42 through the live wire end 451 and the neutral wire end 452 respectively. It is worth noting that the connections of the live wire end 451 and the neutral wire end 452 and the contact points such as the first contact point 431 and the second contact point 432 may be interchangeable. In addition, the second contact point 432 may be connected to the first electric power output terminal 471, and the third contact point 433 may be connected to the second electric power output terminal 472. The first electric power output terminal 471 and the second electric power output terminal 472 are respectively connected with the conductive pieces of the plug hole. In practice, the socket device 40a may have several pairs of first electric power output terminals 471 and second electric power output terminals 472. That is, the socket device 40a may be a multi-socket extension cord device while the electric power input interface 42 may be a plug.

As shown in FIG. 4B, the switch circuit 4b may be utilized in a socket device 40b. The switch circuit 4b may be substantially the same as the switch circuit 4a other than a light emitting component 435 and a resistor 437 may be arranged between the switch circuit 4a and 4b. The light emitting component 435 and the resistor 437 may be in a serial connection, and the serially connected light emitting component 435 and resistor 437 may be in a parallel connection with the third contact point 433 and the second contact point 432. The switch circuit 4b may be used in the switch module 2a along with a light.

When the switching part 21 is switched to “on,” the switch component 41 may be electrically connected to the first contact point 431 and the third contact point 433. The light emitting component 435, the resistor 437, and the electric power input interface 42 collectively may form a circuit loop, turning on the light emitting component 435. On the other hand, when the switching part 21 is switched to “off,” the light emitting component 435 may be turned off Thus, the light emitting component 435 may indicate an operating status of the switching part 21.

As shown in FIG. 4C, a switch circuit 4c may be used in an electric appliance device 40c. The switch circuit 4c when compared with the switch circuit 4b may be different in the connection between the third contact point 433 and the second contact point 432 and a load 47. More specifically, the third contact point 433 and the second contact point 432 may be in the parallel connection with the load 47. Therefore, the light emitting component 435 of the switch circuit 4c may be able to indicate that the load 47 is powered up or not.

### Possible Utilities of the Embodiments

According to the embodiments of the present invention, the switch module has clamping units. The switch module is electrically connected with cable by the clamping units, which may simplify the manufacturing processes and the cost thereof Moreover, the cable which is connected with the clamping units may not detach from the clamping units, extending lifespan of the switch module.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims

What is claimed is:

1. A switch module, comprising:
a casing;
a plurality of conductive terminals mounted on the casing, wherein at least one of the conductive terminals serves as a clamping unit, the clamping unit having a first clip arm and a second clip arm, and a passage, reserved between the first clip arm and the second clip arm, for being electrically connected to a conductive core of a cable; and
a switching part pivotally set on the casing, wherein the switching part is configured to selectively contact with two of the conductive terminals simultaneously or only one of the conductive terminals, in order to connect two of the conductive terminals or disconnect one of the conductive terminals from another one of the conductive terminals.

2. The switch module according to claim 1, wherein the first clip arm and the second clip arm pierces an insulation layer of the cable to be electrically connected to the conductive core of the cable.

3. The switch module according to claim 1, wherein the clamping unit further comprises a spike part, the spike part is disposed inside the passage for piercing the insulation layer and being electrically connected to the conductive core of the cable.

4. The switch module according to claim 1, wherein the plurality of conductive terminals include a first conductive terminal, a second conductive terminal, and a third conductive terminal, wherein the first conductive terminal and the second conductive terminal are metal pieces, and the third conductive terminal is the clamping unit.

5. The switch module according to claim 4, further comprising a light emitting component set in the casing, wherein the light emitting component is electrically connected between the second conductive terminal and the third conductive terminal.

6. The switch module according to claim 4, wherein the first conductive terminal and the second conductive terminal is mounted on a first side of the casing, and the third conductive terminal is mounted on a second side of the casing which is opposite to the first side.

7. The switch module according to claim 1, wherein the plurality of conductive terminals include a first conductive terminal, a second conductive terminal, and a third conductive terminal, all of which are all clamping units.

8. The switch module according to claim 1, further comprising a base having a plurality of wire containing slots and a terminal slot, wherein the wire containing slots intersect with the terminal slot, and the terminal slot is for accommodating the conductive terminals.

9. The switch module according to claim 8, wherein the base has a first lump and a second lump, wherein the wire containing slots are located at positions where the first lump and the second lump are located and corresponding to where the conductive terminals are mounted on the casing, and the terminal slot is formed between the first lump and the second lump.

10. A switch module, comprising:
a casing;
a plurality of conductive terminals mounted on the casing;
a switching part pivotally set on the casing, wherein the switching part is configured to selectively contact with two of the conductive terminals simultaneously or only one of the conductive terminals, in order to connect the two conductive terminals or disconnect one of the conductive terminals from another one of the conductive terminals; and
a base including a plurality of wire containing slots and a terminal slot, and each of the wire containing slots has an clamping unit, wherein the wire containing slots intersects with the terminal slot, and the terminal slot is for accommodating the conductive terminals; and wherein the clamping units are for piercing an insulation layer of a cable passing through the wire containing slots in order to be electrically connected to a conductive core of the cable, and when the conductive terminals are contained in the terminal slot, the conductive terminals are in contact with the clamping units.

11. The switch module according to claim 10, wherein the clamping unit includes a first clip arm and a second clip arm between which a passage is formed, wherein the passage is in a gas communication with the wire containing slots and the terminal slot.
